(19) United States
(12) Patent Application Publication
(10) Pub. No.: US 2010/0231013 A1
(43) Pub. Date: Sep. 16, 2010

(54) VEHICLE SEAT, IN PARTICULAR MOTOR VEHICLE SEAT

(76) Inventor: Ulf Schlenker, Erkenbrechtsweiler (DE)

Correspondence Address: MCGLEW & TUTTLE, PC, P.O. BOX 9227, SCARBOROUGH STATION, SCARBOROUGH, NY, 10510-9227, US

(21) Appl. No.: 12/294,467

(22) PCT Filed: Aug. 7, 2007
(86) PCT No.: PCT/EP2007/006953

§ 371 Date: Sep. 25, 2008

(30) Foreign Application Priority Data
Sep. 7, 2006 (DE) 10 2006 041 915.4

(51) Int. Cl. B60N 2/22; B60N 2/427; B60N 2/62

(52) U.S. Cl. 297/216.13; 297/353; 297/383

(57) ABSTRACT

In the case of a vehicle seat (1), in particular motor vehicle seat, a backrest (4) extending in a longitudinal direction of the backrest includes at least a first backrest shell (10) and a second backrest shell (12) in a shell-type construction. The second backrest shell (12) is displaceable and/or pivotable relative to the first backrest shell (10).

### CROSS REFERENCE TO RELATED APPLICATIONS

This application is a United States National Phase application of International Application PCT/EP2007/006953 and claims the benefit of priority under 35 U.S.C. §119 of German patent application DE 10 2006 041 915.4 filed Sep. 7, 2006, the entire contents of which are incorporated herein by reference.

### FIELD OF THE INVENTION

The present invention pertains to a vehicle seat, in particular a motor vehicle seat.

### BACKGROUND OF THE INVENTION

In a known vehicle seat of this type, the backrest as a supporting structure comprises an integrally formed backrest shell.

Other vehicle seats comprise frames as supporting structures. In such vehicle seats it is known, as disclosed for example in GB 2 318 045 A or DE 196 43 977 C2, to allow part of the backrest to pivot forward in the event of a collision. Moreover, a vehicle seat is known from DE 10 2004 016 315 A1, in the seat part thereof the upper leg support and the seat part-side wings being connected to one another and being able to be moved as a common unit in the longitudinal direction of the seat.

### SUMMARY OF THE INVENTION

The object of the invention is to improve a vehicle seat of the aforementioned type.

The supporting structure of the backrest comprises a first backrest shell and a second backrest shell, which are both made in a shell-like construction. By means of the second backrest shell, which is displaceable and/or pivotable relative to the first backrest shell, it is possible to adjust the ergonomic comfort of the backrest, i.e. the backrest may be adapted in height and/or inclination to the body of the occupant by maintaining a lateral support. Moreover, an active crash system may be installed. In the event of a collision from the rear, the backrest may act as a ramp, along which the body of the occupant rises upward and, in an extreme case, passes over the headrest. The active crash system preferably consists in the second backrest shell being moved relative to the first backrest shell in the event of a collision. This movement of the second backrest shell is preferably used to counteract the aforementioned damaging body movement, and to hold the body of the occupant in a secure position, so that the full effect of the headrest may be deployed.

A supporting structural element is to be understood by a “shell”, which on its own fills up the surface area associated therewith and thus remains visible on the rear face (in the case of being associated with the backrest) or lower face (in the case of being associated with the seat part) without requiring cladding or the like at that point. These unclad, unupholstered and uncovered sides are preferably also specifically configured as visible surfaces. In contrast thereto, a supporting structural element is to be understood by a “frame”, which only partially fills up the surface area associated therewith and thus requires cladding on the visible sides.

The two backrest shells provided according to the invention, together with possibly formed and/or attached regions are correspondingly upholstered and covered on the front face or inner face thereof facing the occupant in a manner known per se. Preferably, the cover is fastened (suspended) on the backrest shell and the cushion is arranged between the cover and backrest shell. The cover may also enclose the cushion by the formation of cushion pads, which are attached to the backrest shell. Mixed forms are also possible.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a side view of the invention;

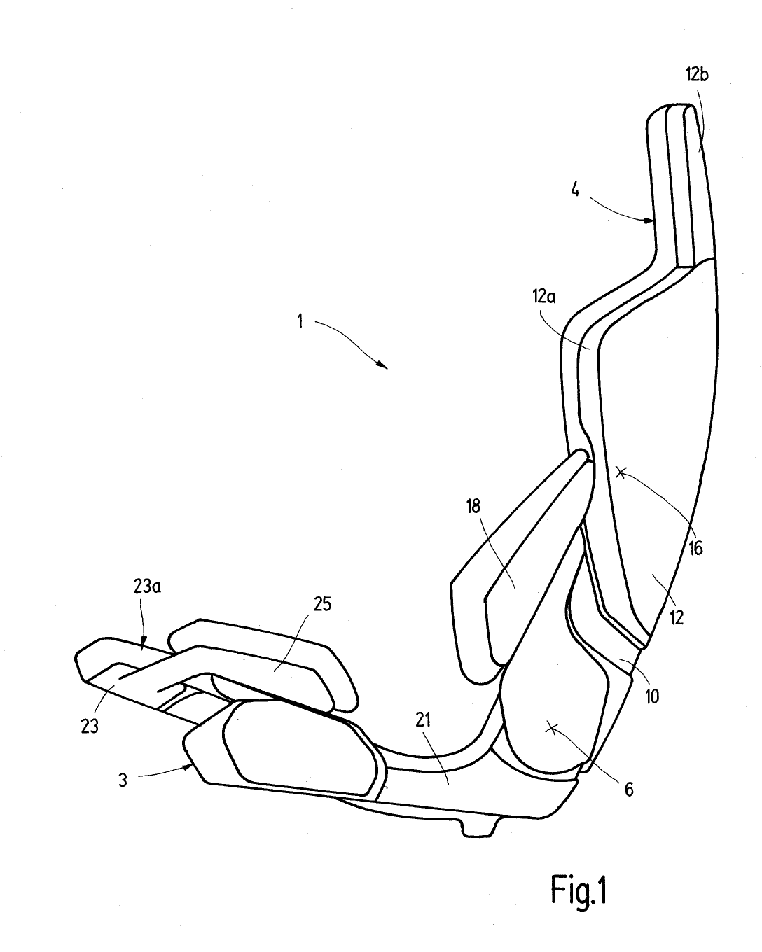

FIG. 2 is a side view of the invention with a backrest adjusted higher relative to FIG. 1;

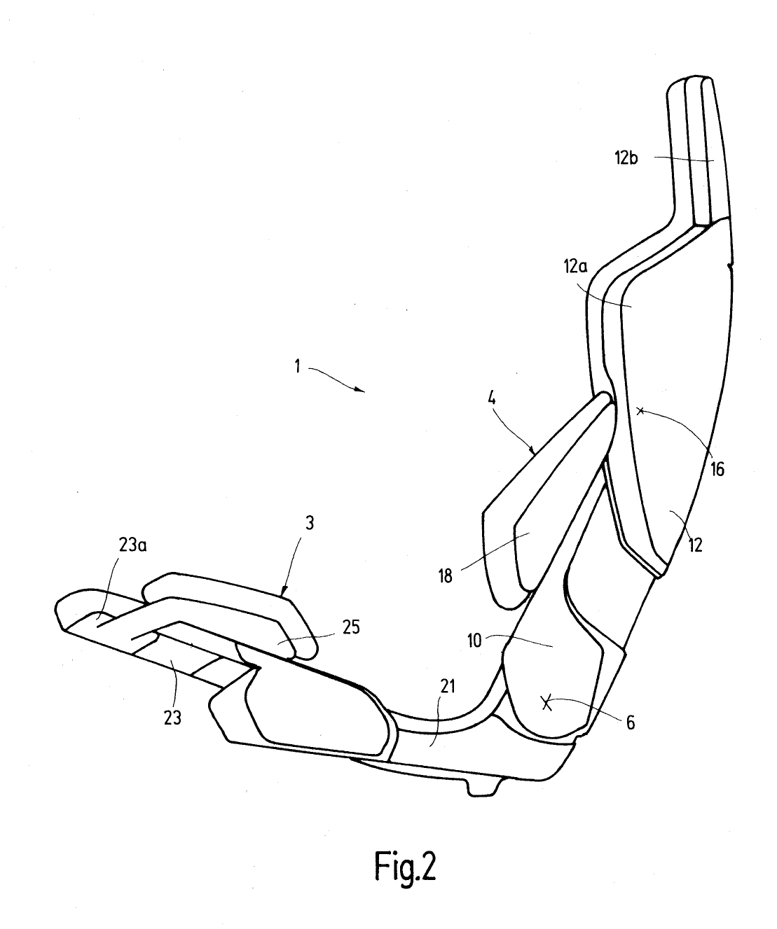

FIG. 3 is a side view of the invention with a backrest pivoted relative to FIG. 2 as a result of the crash function; and

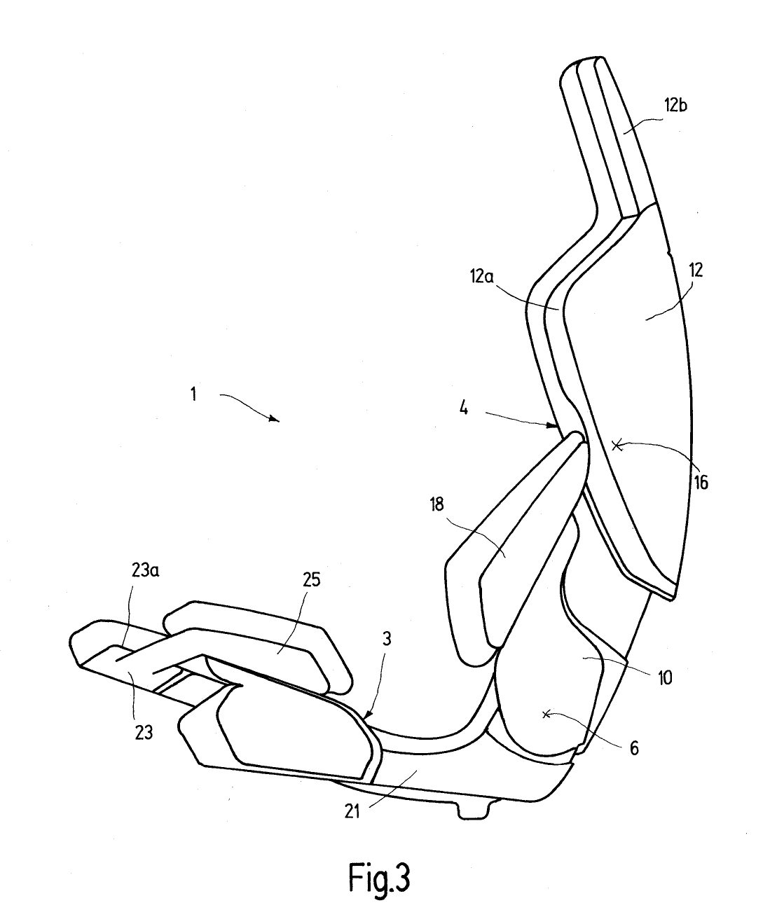

FIG. 4 is a schematic view of the components of the invention which are movable relative to one another.

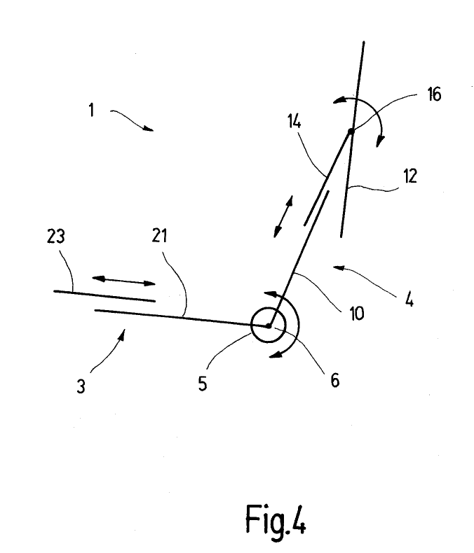

### DESCRIPTION OF THE PREFERRED EMBODIMENTS

Referring to the drawings, a vehicle seat 1 is provided as a front seat for a motor vehicle. The vehicle seat 1 comprises a seat part 3 and a backrest 4, which is attached by means of fittings 5 on both sides of the seat part 3 and is pivotable relative thereto about a backrest pivot axis 6, in the present case with adjustable inclination (in a manual or motorized manner) and freely pivotable. If the fittings 5 are geared fittings, in which two fittings perform a rotary motion with a superimposed wobbling motion relative to one another, the backrest pivot axis 6 is defined by the center of the upper fitting, which in the present case coincides with the pivot axis for the central free pivoting. The seat part 3 defines the longitudinal direction of the seat by its extension in the direction of travel, whilst the backrest 4 defines the longitudinal direction of the backrest by its extension obliquely upward. The longitudinal direction of the seat and the longitudinal direction of the backrest span a plane, to which the backrest pivot axis 6 defining the transverse direction of the seat is perpendicular.

The supporting structure of the vehicle seat 1 is designed in a hybrid shell-like construction, i.e. individual shells produced in a shell-like construction, for example made of glass fiber-reinforced plastics, are supplemented by metal elements. The sides of the shells remote from the occupant are unclad, unupholstered and uncovered and therefore visible. The supporting structure of the backrest 4 comprises a first backrest shell 10 which is attached to the seat part 3 by means of the fittings 5, and a second backrest shell 12 which is arranged—relative to the longitudinal direction of the backrest—higher than the first backrest shell 10 and partially encompasses said first backrest shell on the rear face. A slide 14 is displaceably arranged in the longitudinal direction of the backrest relative to the first backrest shell 10. For example, to this end, pairs of rails may be attached to the front face of the first backrest shell 10 concealed by the cushion. On the slide 14, the second backrest shell 12 is pivotably articulated about a horizontal joint axis 16 parallel to the backrest pivot axis 6, for example by means of two joints aligned with one another.

Above the joint axis 16 on the second backrest shell 12 shoulder supports 12a are formed to the side and a headrest 12b is formed at the top, a multi-part design also being possible. Backrest-side wings 18 are attached to the side of the slide 14 and which are arranged to the side of the first backrest shell 10. The two backrest shells 10 and 12 (with the formed regions and backrest-side wings 18) are upholstered and covered on their front face (and/or inner face) facing the occupant in a manner known per se. The rear faces (and/or outer faces) remote from the occupant of the two backrest shells 10 and 12 (with the formed and attached regions) are configured as unupholstered and uncovered visible surfaces. Overall, a highly contoured backrest 4 results.

The backrest 4 has different possibilities for adjusting the comfort i.e. adaptation to the body shape of the occupant. For height adjustment, the slide 14 may be moved in the longitudinal direction of the backrest, preferably in a motorized or pneumatic/hydraulic manner. The second backrest shell 12 with the formed regions and the backrest-side wings 18 are also modified in height by the slide 14. For adjusting the inclination, firstly the fittings 5 may be actuated, i.e. the entire backrest 4 may be moved relative to the seat part 3 about the backrest pivot axis 6. Secondly, the second backrest shell 12 may be pivoted relative to the slide 14 about the joint axis 16, which preferably also takes place in a motorized or pneumatic/hydraulic manner. For the pivoting motion to the rear, the first backrest shell 10 serves as a stop. The backrest-side wings 18 may be able to be altered in their shape, in a manner known per se, preferably pneumatically.

The backrest 4 also has an active crash system, which counteracts an upward ramp effect of the backrest 4 in the event of a collision from the rear. Additionally to the inclination adjustment about the joint axis 16 a rocker is provided, as is known for example from GB 2 318 045 A or DE 196 43 977 C2, the disclosure thereof relative thereto being expressly included. In the event of a collision from the rear, the occupant presses with the upper part of the back below the joint axis 16 at least indirectly against the second backrest shell 12, preferably against a plate connected to the second backrest shell 12. As a result, the second backrest shell 12 pivots forward and catches more easily the body of the occupant moving upward.

The seat part 3 is also of multi-part construction. A first seat part shell 21 is connected at the bottom to the structure of the motor vehicle, possibly by the interposition of seat rails for the longitudinal adjustment and supports the backrest 4 by means of the fittings 5. A second seat part shell 23 is displaceably arranged in the longitudinal direction of the seat relative to the first seat part shell 21, for example attached by means of pairs of rails on the upper face of the first seat part shell 21 concealed by the cushion. The second seat part shell 23 arranged further forward relative to the first seat part shell 21 has an upper leg support 23a as well as one respective seat part-side wing 25 to the side. The second seat part shell 23 is used for adjusting the comfort, i.e. an adaptation to the body shape of the occupant. The second seat part shell 23 may be moved in the longitudinal direction of the seat, preferably in a motorized or pneumatic/hydraulic manner, whereby the length of the seat surface is adjusted and thus improved support of the upper legs from below is achieved. At the same time, the seat part-side wings 25 move therewith, whereby the lateral support of the upper legs is also maintained for longer upper legs.

In particular, when the vehicle seat 1 is only able to be adjusted to a small extent in a motorized manner, it may be advantageous if there is a forced coupling between the movement of the second seat shell 23 in the longitudinal direction of the seat and the movement of the second backrest shell 12 in the longitudinal direction of the backrest. Thus, when the backrest shell 12 is moved further upward, the second seat shell 23 moves further forward. The same applies to the reverse direction of motion.

While a specific embodiment of the invention has been shown and described in detail to illustrate the application of the principles of the invention, it will be understood that the invention may be embodied otherwise without departing from such principles.

1. A vehicle seat, in particular motor vehicle seat, comprising:
a backrest extending in a longitudinal direction, said backrest comprising at least one first backrest shell in a shell-like construction, said backrest comprising a second backrest shell in a shell-like construction which is displaceable and/or pivotable relative to the first backrest shell.

2. A vehicle seat as claimed in claim 1, wherein the second backrest shell is arranged at a position that is higher than a position of the first backrest shell with respect to the longitudinal direction of the backrest.

3. A vehicle seat as claimed in claim 1, wherein the second backrest shell is arranged on a slide, said slide being mounted for movement such that said slide is displaceable relative to the first backrest shell in the longitudinal direction of the backrest.

4. A vehicle seat as claimed in claim 3, wherein backrest-side wings are arranged to a side of the slide.

5. A vehicle seat as claimed in claim 1, wherein the second backrest shell is pivotably mounted such that said second backrest shell pivots about a horizontal joint axis.

6. The vehicle seat as claimed in claim 3, wherein the second backrest shell is connected to the slide.

7. The vehicle seat as claimed in claim 1, wherein the second backrest shell comprises lateral shoulder supports and/or a headrest which are formed on the second backrest shell.

8. The vehicle seat as claimed in claim 1, said second backrest shell moves relative to the first backrest shell, and pivots forward, in the event of a collision.

9. The vehicle seat as claimed in claim 1, wherein the second backrest shell overlaps a portion of a rear surface of the first backrest shell.

10. The vehicle seat as claimed in claim 1, wherein the height and/or inclination of the backrest is adjusted in a motorized and/or pneumatic/hydraulic manner.

11. The vehicle seat as claimed in claim 1, further comprising a seat part, said seat part comprising a first seat part shell and a second seat part shell displaceable and/or pivotable relative to the first seat part shell in a longitudinal direction of the seat.

12. The vehicle seat as claimed in claim 11, wherein a forced coupling is provided between the movement of the second seat shell in the longitudinal direction of the seat and the movement of the second backrest shell in the longitudinal direction of the backrest.

13. The vehicle seat as claimed in claim 11, wherein the second seat shell has an upper leg support and/or seat part-side wings.

14. The vehicle seat as claimed in claim 5, wherein the second backrest shell is articulated to a slide.

15. The vehicle seat as claimed in claim 12, wherein the second seat shell has an upper leg support and/or seat part-side wings.

16. A vehicle seat for a motor vehicle, comprising:
a first backrest part;
a second backrest part;
a backrest part moving means for moving said second backrest part in a longitudinal direction with respect to said first backrest part from a non-extended second backrest part position to an extended second backrest part position, said first backrest part being connected to said backrest part moving means, said second backrest part being pivotably connected to said backrest part moving means such that said second backrest part moves from a non-pivoted position to a pivoted position;
a first seat part, said first backrest part being pivotably connected to said first seat part;
a second seat part connected to said first seat part such that said second seat part is movable in a longitudinal direction of said first seat part from a non-extended second seat part position to an extended second seat part position.

17. A vehicle seat according to claim 16, wherein said second seat part moves from said non-extended second seat part position to said extended second seat part position when said second backrest part moves from said non-extended second backrest part position to said extended second backrest part position.

18. A vehicle seat according to claim 16, wherein said second backrest part is in said pivoted position when the motor vehicle is in a collision.

19. A vehicle seat for a motor vehicle, comprising:
a backrest structure comprising a first backrest part, a second backrest part and a second backrest part adjusting element, said second backrest part being connected to said first backrest part via said second backrest part adjusting element, said second backrest part being connected to said second backrest part adjusting element such that said second backrest part pivots from a substantially vertical position to a non-vertical position when the motor vehicle is in a collosion, said second backrest part adjusting element being movably mounted to said first backrest part such that said second backrest part is movable from a non-extended second backrest part position to an extended second backrest part position.

20. A vehicle seat according to claim 19, further comprising:
a seat structure including a first seat part and a second seat part, said backrest structure being pivotably connected to said seat structure, said second seat part being connected to said first seat part such that said second seat part is movable in a substantially horizontal direction from a non-extended second seat part position to an extended second seat part position, said second seat part moving from said non-extended second seat part position to said extended second seat part position when said second backrest part moves from said non-extended second backrest part position to said extended second backrest part position.
